(19) United States
(12) Patent Application Publication
(10) Pub. No.: US 2006/0154147 A1
(43) Pub. Date: Jul. 13, 2006

(54) Carbon material for electrode and method for producing same, battery electrode and method for producing same, and battery and method for producing same

(75) Inventors: Masato Kurihara, Tokyo (JP); Satoshi Maruyama, Tokyo (JP); Takamasa Ishigaki, Ibaraki (JP)

Correspondence Address: OLIFF & BERRIDGE, PLC, P.O. BOX 19928, ALEXANDRIA, VA, 22320, US

(73) Assignees: TDK CORPORATION, Tokyo (JP); NATIONAL INSTITUTE FOR MATERIALS SCIENCE, Ibaraki (JP)

(21) Appl. No.: 10/561,955

(22) PCT Filed: Jun. 30, 2004
(86) PCT No.: PCT/JP04/09188

§ 371 Date: Jan. 23, 2006

(30) Foreign Application Priority Data
Jun. 30, 2003 (JP) 2003-188517

(51) Int. Cl. H01M 4/58; H01M 4/04; C01B 31/02

(52) U.S. Cl. 429/231.8; 252/182.1; 423/445 R

(57) ABSTRACT

The electrode carbon material of the present invention is an electrode carbon material to become a constituent material for an electrode of a nonaqueous electrolyte battery, wherein the electrode carbon material is formed by way of a plasma processing step of subjecting a material composition to high-frequency thermal plasma processing in a plasma gas atmosphere including a sulfur-containing compound.

### TECHNICAL FIELD

The present invention relates to an electrode carbon material for a nonaqueous electrolyte battery and a method of manufacturing the same, an electrode for a nonaqueous electrolyte battery and a method of manufacturing the same, and a nonaqueous battery and a method of manufacturing the same.

### BACKGROUND ART

In recent years, mobile electronic devices have remarkably been reducing their size and weight and enhancing their functions, along which a higher energy density has been demanded for rechargeable batteries which are power supplies for these devices. Among the rechargeable batteries, in particular, lithium-ion rechargeable batteries using lithium cobaltate and a carbon material as their cathode and anode, respectively, have widely been used as ‘rechargeable batteries having a high energy density in cellular’ phones and the like.

In order for such a lithium-ion rechargeable battery to attain a higher performance, the selection of electrode materials is important. The carbon material acting as a constituent material of the anode has a wide range of diversity, whereby various carbon materials ranging from highly crystallite graphite to carbonized polymers have been under consideration.

Electrochemical characteristics of a battery such as charge-discharge potential, reversible capacity, and cycle characteristic heavily depend on the degree of crystallinity (degree of graphitization), surface mode, inner structure, surface chemical composition, and the like of a carbon material employed as an anode active material (negative electrode active material). In lithium-ion rechargeable batteries using a carbon material for an anode active material, SEI (Solid Electrolyte Interface) formed on the anode active material surface at the time of initial charging greatly affects characteristics. The SEI is generated by a reaction between the anode active material and an electrolytic solution. Once the SEI is formed, further reactions are suppressed, whereby lithium can be inserted between layers of graphite. However, the SEI is one of causes for irreversible capacities. The thermal stability concerning the safety of batteries depends on the stability of SEI. The SEI is formed by the reaction between the anode active material and the electrolytic solution in terms of mechanism, and is greatly influenced by the amount of oxygen-containing functional groups such as carboxyl and carbonyl groups on carbon particle surfaces and surface structures of carbon materials such as surface crystallinity of carbon particles.

For solving such a problem and yielding favorable electrode characteristics and battery characteristics, reducing irreversible capacities in particular, methods of manufacturing a carbon material subjected to thermal plasma processing have been proposed (see Patent Documents 1 and 2), for example.

Patent Document 1: Japanese Patent Application Laid-Open No. HEI 10-92432

Patent Document 2: Japanese Patent Application Laid-Open No. 2000-223121

### DISCLOSURE OF THE INVENTION

### PROBLEM TO BE SOLVED BY THE INVENTION

However, even an electrode containing a carbon material subjected to thermal plasma processing as a constituent material and a battery using the same such as those disclosed in the above-mentioned Patent Documents 1 and 2 fail to yield sufficient electrode characteristics and battery characteristics, thus leaving room for further improvement.

In view of the problems of the prior art mentioned above, it is an object of the present invention to provide an electrode carbon material and a method of manufacturing the same, which can sufficiently reduce the irreversible capacity. It is another object of the present invention to provide an electrode and a method of manufacturing the same, which can sufficiently reduce the irreversible capacity. It is a further object of the present invention to provide a battery and a method of manufacturing the same, which can sufficiently reduce the irreversible capacity and yield a sufficient reversible capacity and charging and discharging efficiency (initial charging and discharging efficiency in particular).

### MEANS FOR SOLVING PROBLEM

The inventors conducted diligent studies in order to achieve the above-mentioned object and, as a result, have found that the above-mentioned object can be achieved when using an electrode carbon material formed by subjecting a material compound to high-frequency thermal plasma processing in a predetermined plasma gas atmosphere, thereby accomplishing the present invention.

Namely, in one aspect, the present invention provides an electrode carbon material to become a constituent material for an electrode of a nonaqueous electrolyte battery, wherein the electrode carbon material is formed by way of a plasma processing step of subjecting a material composition to high-frequency thermal plasma processing in a plasma gas atmosphere including a sulfur-containing compound.

Here, the high-frequency thermal plasma is a plasma generated at a pressure ranging from a medium pressure (about 10 to 70 kPa) to 1 atmosphere (101.325 kPa), and yields a plasma approaching a thermal equilibrium unlike a normal low-pressure plasma, thereby being able to heat substances existing in the system to a high temperature as well as simply performing local reaction by a plasma and the like. Therefore, the high-frequency thermal plasma enables both of high-temperature phase generation and surface modification. Examples of specific phenomena seem to include surface nitrogenization when N₂ is used for the plasma gas, surface hydrogenization when H₂ is used therefor, physical breakdown at an atomic level, and cleaning of particle surfaces.

When the high-frequency thermal plasma is used for surface processing of carbon particles, a material composition (carbon material or resin material) is graphitized by ultrahigh temperature treatment with a high-frequency thermal plasma atmosphere, and the surface is further modified by bombardment with ions, radicals, etc.

Since the electrode carbon material of the present invention is subjected to high-frequency plasma processing, a turbostratic structure occurs in the vicinity of the material surface, whereas the trace of oxygen and hydrogen existing on the material surface is eliminated, whereby the surface is reformed. Since the plasma processing is performed in the plasma gas atmosphere including a sulfur-containing compound in particular, elementary sulfur or a sulfur-containing functional group including sulfur is introduced onto the material surface, whereby the presence of these sulfur components can make the SEI producing reaction favorable and improve the stability of SEI. This can sufficiently reduce the irreversible capacity generated by the SEI and can add a reversible capacity due to the sulfur component. Therefore, using the electrode carbon material of the present invention as a constituent material for an electrode can improve the reversible capacity and charging and discharging efficiency (initial charging and discharging efficiency in particular) of a battery equipped with this electrode.

In another aspect, the present invention provides an electrode for a nonaqueous electrolyte battery, the electrode comprising an active material containing layer including the electrode carbon material of the present invention and a binder capable of binding the electrode carbon material as constituent materials, and a conductive collector arranged in a state electrically in contact with the active material containing layer.

In still another aspect, the present invention provides a nonaqueous electrolyte battery comprising an anode, a cathode, and an electrolyte layer, arranged between the anode and cathode, including a nonaqueous electrolyte, wherein at least one of the anode and cathode is the electrode of the present invention.

Since the electrode and battery use the electrode carbon material of the present invention as a constituent material, the electrode can sufficiently reduce the irreversible capacity, whereas the battery can sufficiently reduce the irreversible capacity and can attain a sufficient reversible capacity and charging and discharging efficiency (initial charging and discharging efficiency in particular).

In still another aspect, the present invention provides a method of manufacturing an electrode carbon material to become a constituent material for an electrode of a nonaqueous electrolyte battery, the method including a plasma processing step of subjecting a material composition to high-frequency thermal plasma processing in a plasma gas atmosphere including a sulfur-containing compound.

This manufacturing method can efficiently and reliably yield the electrode carbon material of the present invention exhibiting the effects mentioned above.

In still another aspect, the present invention provides a method of manufacturing an electrode for a nonaqueous electrolyte battery, the method including a plasma processing step of subjecting a material composition to high-frequency thermal plasma processing in a plasma gas atmosphere including a sulfur-containing compound, so as to yield an electrode carbon material; and an active material containing layer forming step of forming an active material containing layer of the electrode by using the electrode carbon material. Preferably, this manufacturing method further comprises a storing step of sealing the electrode formed in the active material containing layer forming step into a case capable of storing the electrode in a closed state.

In still another aspect, the present invention provides a method of manufacturing a nonaqueous electrolyte battery comprising an anode, a cathode, and an electrolyte layer, arranged between the anode and cathode, including a nonaqueous electrolyte; the method including an electrode forming step of forming at least one of the anode and cathode by way of the method of manufacturing an electrode in accordance with the present invention.

Preferably, all the manufacturing steps in the method of manufacturing an electrode and all the manufacturing steps in the method of manufacturing a battery are performed in an inert gas atmosphere.

The methods of manufacturing an electrode and a nonaqueous electrolyte battery can efficiently and reliably yield the electrode and nonaqueous electrolyte battery of the present invention exhibiting the effects mentioned above.

Performing all the manufacturing steps in an inert gas atmosphere can yield the following effects. Namely, when a carbon material (electrode carbon material) subjected to high-frequency plasma processing was analyzed with a thermal desorption mass spectrometer (TDS), a large amount of a gas derived from a hydroxyl group was found to be generated from the electrode carbon material surface. In general, the electrode carbon material is once exposed to air when collected from a high-frequency thermal plasma processing apparatus and then is bound by a binder, so as to become an electrode to be incorporated into a battery using a nonaqueous solvent. The hydroxyl group on the electrode carbon material surface seems to derive from oxygen and hydrogen in the air to which the material is exposed after the high-frequency thermal plasma processing.

Therefore, the inventors made an electrode in an inert gas atmosphere without exposing the electrode carbon material to the air after the surface processing (high-frequency thermal plasma processing) and further produced a battery. Thus produced battery was found to yield a reversible capacity and a charging and discharging efficiency which were better than those of batteries made by the conventional method in which the electrode carbon material was exposed to the air.

This seems to be because of the fact that no moisture was absorbed by the electrode carbon material surface so that no increase in irreversible capacity (no decrease in initial charging and discharging efficiency) caused by electrolysis of water. It is also presumed that, since excessive functional groups such as hydroxyl group were not absorbed by the electrode carbon material surface, the amount of production of SEI became appropriate, whereby the irreversible capacity decreased.

Effect of the Invention

The present invention can provide an electrode carbon material which can sufficiently reduce the irreversible capacity. Also, the present invention can provide an electrode which can sufficiently reduce the irreversible capacity. Further, the present invention can provide a nonaqueous electrolyte battery which can sufficiently reduce the irreversible capacity and yield a sufficient reversible capacity and charging and discharging efficiency. (initial charging and discharging efficiency in particular).

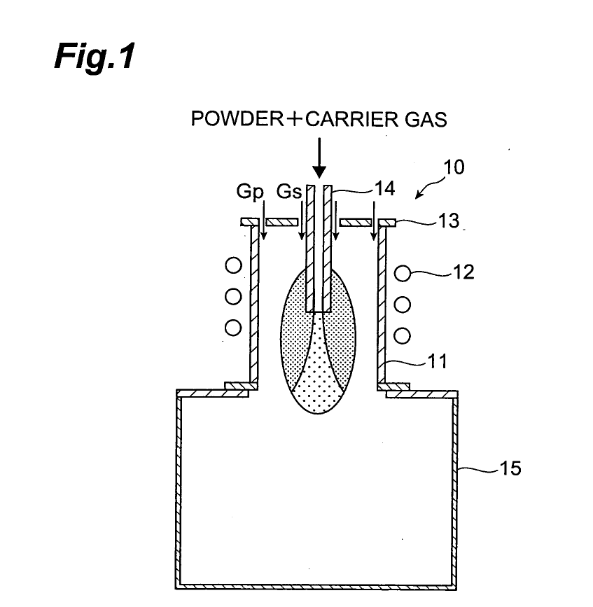

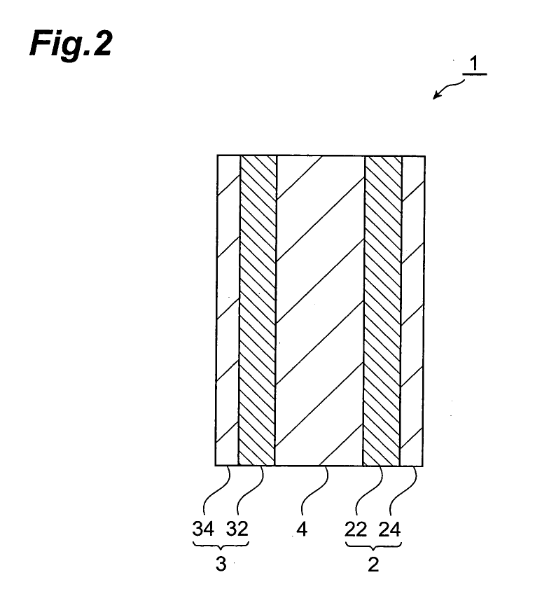

Furthermore, the present invention can provide methods which can easily and reliably yield the electrode carbon material, electrode, and nonaqueous electrolyte battery of the present invention. Brief Description of the Drawings

[FIG. 1]FIG. 1 is a schematic diagram of a high-frequency thermal plasma generating apparatus (plasma torch) used for high-frequency thermal plasma processing in the present invention; and [FIG. 2]FIG. 2 is a schematic sectional view showing a basic configuration of a preferred embodiment (lithium-ion rechargeable battery) of the nonaqueous electrolyte battery in accordance with the present invention.

### EXPLANATIONS OF NUMERALS

1 . . . battery; 2 . . . anode; 3 . . . cathode; 4 . . . electrolyte layer; 10 . . . high-frequency thermal plasma generating apparatus (plasma torch); 11 . . . water-cooled double tube; 12 . . . high-frequency coil; 13 . . . lid; 14 . . . powder-supplying water-cooled probe; 15 . . . chamber; 22 . . . active material containing layer; 24 . . . collector; 32 . . . active material containing layer; 34 . . . collector.

### BEST MODES FOR CARRYING OUT THE INVENTION

In the following, preferred embodiments of the present invention will be explained in detail with reference to the drawings. In the following explanation, parts identical or equivalent to each other will be referred to with numerals identical to each other without repeating their overlapping descriptions.

Electrode Carbon Material and Method of Manufacturing the Same

The electrode carbon material of the present invention is one formed by way of a plasma processing step of subjecting a material composition to high-frequency thermal plasma processing in a plasma gas atmosphere including a sulfur-containing compound.

Examples of the material composition include carbon materials (carbonaceous materials) and materials to become carbon materials upon high-frequency thermal plasma processing.

Examples of the material composition to become carbon materials upon high-frequency thermal plasma processing include various resins such as phenol resins, acrylic resins, furan resins, polyvinylidene chloride (PVDC), linear vinyl polymers such as polyacrylonitrile, and polymers made of biphenyl bonds such as polyphenylene. Also usable are nitrogen-containing resins, e.g., polyaniline, polyimide, polyamide such as nylon, and nitrogen-containing phenol resins. Various sugars such as polysaccharides can also be used. Preferred among them are phenol resins, truly spherical phenol resins in particular.

Examples of the material composition made of carbon material include graphite, glassy carbon, pyrolytic graphite, carbon fiber, carbon paste, and activated carbon, among which graphite-based carbon materials are preferred in particular.

The graphite-based carbon materials are not restricted in particular as long as they are graphite or those having a crystallinity close to that of graphite, examples of which include natural graphite, artificial graphite, and mesophase carbon microbead (MCMB). Among them, MCMB is preferred in particular. The MCMB is formed by graphitizing a truly spherical carbon material obtained from pitch, and is easier to handle than conventional graphite materials in the making of electrode materials. Namely, it is excellent in fluidity and thus is suitable for high-frequency thermal plasma processing, capable of mass processing, and prone to become excellent in productivity. Also, a film is easier to make when forming an electrode.

As described in Kirk-Othmar Encyclopedia of Chemical Technology, Japanese edition (Maruzen), p. 824, terms “carbon” and “graphite” which are often confused with each other are not originally synonymous with each other. Namely, those generically referred to as “carbon” such as carbon, artificial graphite, amorphous carbon, and fired carbon are products obtained by mixing solid carbon particles (petroleum coke, carbon black, anthracite, etc.) known as filler (aggregate) into a binder such as coal tar pitch or petroleum pitch, shaping the resulting mixture by molding or extruding, and then firing the shaped product at 1,800 to 1,400° C. in a furnace in an inert atmosphere. The filler is a material (also known as fill) constituting a body of the final product. The shaped body before firing is referred to as green carbon (raw shaped article). On the other hand, those generically referred to as “graphite” such as man-made (artificial ) graphite, synthetic graphite, electrographite, and graphitized carbon are carbon materials obtained by further heat-treating the above-mentioned carbon at a high temperature of at least 2,400° C. (preferably 2,800 to 3,000° C.). According to this definition, the MCMB is one formed by graphitizing the carbon obtained from pitch. While the MCMB obtained from pitch is widely used at present, any graphite-based carbon material such as truly spherical one is employable in the present invention as long as it exhibits a favorable fluidity, whereby any of carbon-based materials and those obtained by way of graphitizing processes may be used.

The material subjected to high-frequency thermal plasma processing and the carbon material (electrode carbon material) after high-frequency thermal plasma processing are preferably particulate or powdery, while their average particle size is preferably on the order of 0.5 to 100 μm. These particles are preferably spherical, but may have forms other than spherical one such as ellipsoidal and amorphous forms, for example.

The plasma processing step will now be explained. The plasma processing step is a step of subjecting the material composition to high-frequency thermal plasma processing in a plasma gas atmosphere including a sulfur-containing compound. The high-frequency thermal plasma processing in the present invention can be performed according to “Ishigaki, Takamasa, Ceramics, 30 (1995), No. 11, 1013-1016”, Japanese Patent Application Laid-Open No. HEI 7-31873, the above-mentioned Patent Document 1 (Japanese Patent Application Laid-Open No. HEI 10-92432), and the above-mentioned Patent Document 2 (Japanese Patent Application Laid-Open No. 2000-223121), for example.

For the high-frequency thermal plasma processing in the present invention, a high-frequency thermal plasma generating apparatus (thermal plasma torch) 10 shown in FIG. 1 is used. This apparatus 10 continuously introduces an object into a plasma torch and collects it in the lower part. The apparatus (torch) 10 of FIG. 1 includes a high-frequency coil 12 wound about the outside of a water-cooled double tube 11, and forms a thermal plasma therein by high-frequency electromagnetic induction. A lid 13 is attached to the upper part of the water-cooled double tube 11, whereas the lid 13 is equipped with a powder-supplying water-cooled probe 14 for supplying powders of the material composition to be subjected to high-frequency thermal plasma processing and a carrier gas. Placed at the lower part of the water-cooled double tube 11 is a chamber 15 for collecting the electrode carbon material. A central gas (Gp) mainly used for forming a plasma flow and a sheath gas (Gs) mainly used for surrounding the outside of the plasma flow are introduced into the apparatus 10. In the present invention, the central gas, sheath gas, and carrier gas are collectively referred to as plasma gas.

In the present invention, the plasma gas includes a sulfur-containing compound therein, whereas the high-frequency thermal plasma processing is performed in the plasma gas including a sulfur-containing compound. Here, though it will be sufficient if the sulfur-containing compound is included in any of the central gas, sheath gas, and carrier gas, the sulfur-containing compound is preferably contained at least in the carrier gas. When the sulfur-containing compound is included in the carrier gas, the material composition and the sulfur-containing compound are more likely to come into contact with each other in the high-frequency thermal plasma processing, so as to improve the sulfur content in the electrode carbon material, whereby the effects of the present invention are easier to obtain.

The sulfur-containing compound used in the present invention is not limited in particular as long as it is a compound having a sulfur atom within its molecule, but may be in any of states of gas, liquid, and solid and is preferably in a gas state because of its easiness of introduction. Specific examples of the sulfur-containing compound include SF₆, H₂S, and SO₂, among which SF₆ is preferred. When the sulfur-containing compound is in a gas state, the sulfur-containing compound content in the plasma gas is preferably 0.5 to 35 vol % in the total amount of plasma gas. When the sulfur-containing compound in a gas state is included in the carrier gas, the sulfur-containing compound content in the carrier gas is preferably 4 to 80 vol % in the total amount of carrier gas. When the sulfur-containing compound content falls within these ranges, the electrode carbon material tends to be able to contain sulfur more efficiently and reliably.

As the plasma gas other than the sulfur-containing compound, at least Ar is preferably used, and at least one species selected from N₂, H₂, CO₂, and CO is more preferably used together with Ar. In particular, it will be preferred if N₂ or H₂ is used together with Ar or further with CO₂ in addition thereto. The content of gases other than Ar in the plasma gas is preferably 1 to 20 vol % in the total amount of plasma gas. Species of gases used in the central gas, sheath gas, and carrier gas are not restricted in particular, but each preferably contains Ar. In particular, for protecting the inner wall of the torch, the sheath gas preferably contains a diatomic gas such as N₂ or H₂ mixed therein. When at least H₂ is used as a plasma gas, the initial charging and discharging efficiency tends to be able to improve more fully. The total flow rate of the central gas and sheath gas (including the sulfur-containing compound if any) is usually 2 to 200 L/min, preferably 30 to 130 L/min.

The amount of the material composition introduced is preferably 1 to 500 g/min, whereas the flow rate of the carrier gas (including the sulfur-containing compound if any) is preferably 1 to 100 L/min.

Appropriating selecting the plasma gas can regulate effects caused by high-frequency plasma processing. For example, since H₂ exhibits a thermal conductivity higher than that of N₂, the heating efficiency usually tends to become higher when H₂ is used.

The high-frequency thermal plasma is generated under a condition where the frequency is usually 0.5 to 6 MHz, preferably 3 to 6 MHz, the input power is 3 to 60 kW, and the pressure within the torch is 1 to 100 kPa, more preferably 10 to 70 kPa.

Using such an apparatus 10 enables high-frequency thermal plasma processing at 3,000 to 15,000° C. In the present invention, the dwell time for the material composition in the temperature range of 3,000 to 15,000° C. is preferably on the order of 0.001 to 10 seconds, 0.02 to 0.5 second in particular.

Though the size of the plasma torch is not restricted in particular, the tube diameter is preferably 10 to 1,000 mm, more preferably 50 to 100 mm, whereas the height is preferably 50 to 3,000 mm, more preferably 200 to 3,000 mm in the structure shown in FIG. 1.

The material component may be subjected to high-frequency thermal plasma processing either by itself or in a state mixed with an oxide. Preferred examples of the oxide used in this case include lithium cobaltate (LiCoO₂), lithium nickelate (LiNiO₂), lithium manganate (LiO₂), lithium manganese spinel (LiMn₂O₄), lithium vanadium compounds, V₂O₅, and olivine-type LiMPO₄ (where M is Co, Ni, Mn, or Fe). The amount of oxide compounded is preferably 5, mass % or less on the basis of the total amount of the mixture (material composition+oxide).

Though the carbon material in the present invention is a concept encompassing materials made of pure carbon and materials containing elements other than carbon as well, the content of elements other than carbon and sulfur in the electrode carbon material is preferably 3 mass % or less after the high-frequency thermal plasma processing, since the resistivity becomes higher when a large amount of elements other than carbon is contained. The elements other than carbon and sulfur mainly derive from the material composition before carbonization, whereas their examples include nitrogen and hydrogen.

In the electrode carbon material of the present invention, the BET specific surface area determined from nitrogen adsorption isotherms by using a BET adsorption isotherm equation is preferably 0.5 to 300 m²/g, more preferably 0.8 to 5 m²/g. The electrode carbon material having such a BET specific surface area tends to be able to yield a sufficient battery characteristic when used as a constituent material for the electrode in the nonaqueous electrolyte battery.

The sulfur content in the electrode carbon material of the present invention is preferably 0.02 to 18 mass % on the basis of the total amount of the electrode carbon material. Here, when the electrode carbon material is used as a constituent material for the anode, the sulfur content in the electrode carbon material is preferably 0.02 to 6 mass %. When the electrode carbon material is used as a constituent material for the cathode, the sulfur content in the electrode carbon material is preferably 1.2 to 18 mass %.

The electrode carbon material of the present invention preferably enables insertion and desorption (intercalation or doping/dedoping) of lithium ions, and preferably becomes a constituent material for an electrode of a lithium-ion rechargeable battery.

Electrode and Method of Manufacturing the Same

The electrode of the present invention, which is an electrode for a nonaqueous electrolyte battery, comprises an active material containing layer including the above-mentioned electrode carbon material of the present invention and a binder which can bind the electrode carbon material as constituent materials, and a conductive collector arranged in a state electrically in contact with the active material containing layer.

First, the active material containing layer will be explained. The active material containing layer is a layer formed such as to contain at least the electrode carbon material and the binder as constituent materials. The binder is not restricted in particular as long as it can bind the electrode carbon material, whereby fluorine resins such as polyvinylidene chloride (PVDF), polytetrafluoroethylene (PTFE), tetrafluoroethylene/hexafluoropropylene copolymer (FEP), tetrafluoroethylene/perfluoroalkylvinylether copolymer (PFA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF); vinylidene-fluoride-based fluorine rubbers such as vinylidene-fluoride/hexafluoropropylene-based fluorine rubber (VDF/HFP-based fluorine rubber), vinylidene-fluoride/hexafluoropropylene/tetrafluoroethylene-based fluorine rubber (VDF/HFP/TFE-based rubber), vinylidene-fluoride/pentafluoropropylene-based fluorine rubber (VDF/PFP-based fluorine rubber), vinylidene-fluoride/pentafluoropropylene/tetrafluoroethylene-based fluorine rubber (VDF/PFP/TFE-based fluorine rubber), vinylidene-fluoride/perfluoromethylvinylether/tetrafluoroethylene-based fluorine rubber (VDF/PFMVE/TFE-based rubber), and vinylidene-fluoride/chlorotrifluoroethylene-based fluorine rubber (VDF/CTFE-based fluorine rubber); tetrafluoroethylene/propylene-based fluorine rubber (TFE/P-based fluorine rubber); tetrafluoroethylene/perfluoroalkylvinylether-based rubber; thermoplastic fluorine rubber (e.g., DAI-EL Thermoplastic manufactured by Daikin Industries, Ltd.); and the like can be used, for example. As a binder other than those based on fluorine, styrene-butadiene rubber (SBR) and the like can be used.

Preferably, the active material containing layer contains a conductive auxiliary agent. Examples of the conductive auxiliary agent include carbon black, graphite, acetylene black, and conductive oxides and nitrides.

The active material containing layer may further contain an oxide. Examples of the oxide include those used at the time of the above-mentioned high-frequency thermal plasma processing.

When necessary, the active material containing layer may further contain silicon, tin, lead, and the like in addition to the foregoing constituent materials.

The following are preferred contents of the constituent materials in the active material containing layer. Namely, the content of the electrode carbon material is preferably 80 to 100 mass %, more preferably 92 to 96 mass %, on the basis of the total solid amount in the active material containing layer. The amount of the binder compounded is preferably 0 to 20 mass %, more preferably 2 to 6 mass %, on the basis of the total solid amount in the active material containing layer. When the conductive auxiliary agent is contained, its content is preferably 2 to 10 mass % on the basis of the total solid amount in the active material containing layer. When the oxide is contained, its content is preferably 3 to 7 mass % on the basis of the total solid amount in the active material containing layer.

The collector will now be explained. The collector in the electrode of the present invention is not restricted in particular, whereby band-like pieces in which aluminum, copper, nickel, titanium, stainless steel, and the like are formed into foils, perforated foils, meshes, and the like are used, for example. Also usable are porous materials such as porous metals (foamed metals) and carbon paper.

The method of manufacturing an electrode in accordance with the present invention will now be explained. The method of manufacturing an electrode in accordance with the present invention is a method including the above-mentioned plasma processing step, and an active material containing layer forming step of forming an active material containing layer including the electrode carbon material obtained by the plasma processing step and a binder capable of binding the electrode carbon material as constituent materials in a state electrically in contact with a conductive collector.

In the active material containing layer forming step, the active material containing layer can be formed by using a known thin-film manufacturing technique for an electrode, for example, by a dry method or wet method which will be explained in the following.

The dry method is a method forming an electrode without using a solvent. For example, the above-mentioned constituent materials for the active material containing layer (the electrode carbon material, the binder, and various additives such as the conductive auxiliary agent) are mixed, and the resulting mixture is fed to a hot roller, so as to be extended under heat and pressure into a sheet form. Here, the surface temperature of the hot roller is preferably 60 to 120° C., whereas its linear pressure is preferably 10 to 5,000 kg/cm. When the active material containing layer is formed by the dry method, particles themselves are extended, whereby a higher density is easily attained, whereas no solvent is necessary, which is advantageous in that safety is high. The collector and the active material containing layer may be brought into electric contact with each other after shaping the active material containing layer with the hot roller, or the shaping of the active material containing layer into a sheet and the establishing of electrical connection between the active material containing layer and the collector may be carried out simultaneously by feeding the hot roller with the collector and constituent materials of the active material containing layer dispersed over one face of the collector.

On the other hand, the wet method comprises, for example, the steps of preparing an active material containing layer forming coating liquid by dissolving or dispersing the above-mentioned constituent materials for the active material containing layer (the electrode carbon material, the binder, and various additives such as the conductive auxiliary agent) into a solvent, applying thus obtained liquid onto the collector, and drying the liquid.

The solvent employed here is of nonaqueous type. For example, various solvents such as methylethylketone, cyclohexanone, isophorone, N-methylpyrrolidone, N,N-dimethylformamide, N,N-dimethylacetamide, and toluene can selectively be used as appropriate.

The active material containing layer forming coating liquid can be obtained by mixing and dispersing the constituent materials for the active material containing layer with the solvent by a dispersing apparatus such as stirrer, ball mill, super sand mill, or pressure kneader.

The method of applying the coating liquid is not restricted in particular, whereby known methods such as metal mask printing, electrostatic coating, dip coating, spray coating, roll coating, doctor blading, gravure coating, and screen printing can be used, for example. After the coating, extending with a flat press, calender rollers, and the like may be performed as necessary.

Preferably, after the active material containing layer forming step, the method of manufacturing an electrode in accordance with the present invention further comprises a storing step of sealing thus obtained electrode into a case capable of storing the electrode in a closed state.

The electrode obtained by way of the storing step can sufficiently restrain the electrode carbon material included in the electrode from being exposed to the air at the time of keeping the electrode or making a nonaqueous electrolyte battery by using the same. Therefore, using this electrode can yield a nonaqueous electrolyte battery having an excellent reversible capacity and charging and discharging efficiency.

While the electrode of the present invention can be obtained by way of the active material containing layer forming step explained in the foregoing, it will be preferred in the-method of manufacturing an electrode in accordance with the present invention if all the manufacturing steps mentioned above are performed in an inert gas atmosphere. Here, all the manufacturing steps specifically refer to the plasma processing step, the active material containing layer forming step, and the storing step performed when necessary. Thus, it will be preferred if the electrode carbon material is kept from being exposed to the air in each of the manufacturing steps when making the electrode.

Nonaqueous Electrolyte Battery and Method of Manufacturing the Same

FIG. 2 is a schematic sectional view showing a basic configuration of a preferred embodiment (lithium-ion rechargeable battery) of the nonaqueous electrolyte battery in accordance with the present invention. The rechargeable battery 1 shown in FIG. 2 is mainly constituted by an anode 2, a cathode 3, and an electrolyte layer 4 arranged between the anode 2 and cathode 3.

The anode 2 of the rechargeable battery 1 shown in FIG. 2 is constituted by a film-like (planar) collector 24 and a film-like active material containing layer 22 arranged between the collector 24 and electrolyte layer 4. At the time of charging, the anode 2 is connected to an anode of an external power supply (none of which is depicted), so as to function as a cathode. The form of the anode 2 is not restricted in particular, and may be like a thin film as depicted, for example.

The cathode 3 of the rechargeable battery 1 shown in FIG. 2 is constituted by a film-like (planar) collector 34 and a film-like active material containing layer 32 arranged between the collector 34 and electrolyte layer 4. At the time of charging, the cathode 3 is connected to a cathode of an external power supply (none of which is depicted), so as to function as an anode. The form of the cathode 3 is not restricted in particular, and may be like a thin film as depicted, for example.

In the rechargeable battery 1 shown in FIG. 2, at least one of the anode 2 and cathode 3 is the electrode of the present invention mentioned above. When the electrode of the present invention is used as the anode 2, the electrode carbon material of the present invention to become a constituent material of the electrode preferably has a sulfur content of 0.02 to 6 mass % as mentioned above. When the electrode of the present invention is used as the cathode 3, on the other hand, the electrode carbon material of the present invention to become a constituent material of the electrode preferably has a sulfur content of 1.2 to 18 mass % as mentioned above.

In the following, the configuration of the cathode to become a counter electrode when the electrode of the present invention is used only for the anode 2 and the configuration of the anode to become a counter electrode when the electrode of the present invention is used only for the cathode 3 will be explained.

The anode 2 that is not the electrode of the present invention can employ the configuration of a conventionally known anode. For example, an anode formed by an anode active material, a binder, and various additives such as a conductive auxiliary agent can be used. Examples of the anode active material include carbon materials such as graphite, non-graphitizable carbon, graphitizable carbon, and carbons fired at low temperature which enable insertion and desorption (intercalation or doping/dedoping) of lithium ions; metals such as Al, Si, and Sn combinable with lithium; amorphous compounds mainly composed of oxides such as SiO₂ and SnO₂; and lithium titanate (Li₃Ti₅O₁₂). Examples of the binders include the binders used in the electrode of the present invention mentioned above. Examples of the additives include the conductive auxiliary agent and oxides used in the electrode of the present invention mentioned above as necessary.

When the rechargeable battery 1 is a metal lithium rechargeable battery, its anode (not depicted) may be an electrode made of only a metal lithium or lithium alloy also acting as a collector member. The lithium alloy is not restricted in particular, whereby its examples include alloys such as Li—Al, LiSi, and LiSn (LiSi being referred to as an alloy here).

The cathode 3 that is not the electrode of the present invention can employ the configuration of a conventionally known cathode. For example, a cathode formed by a cathode active material (positive electrode active material), a binder, and various additives such as a conductive auxiliary agent can be used. Examples of the cathode active material include lithium cobaltate (LiCoO₂), lithium nickelate (LiNiO₂), lithium manganese spinel (LiMn₂O₄), mixed metal oxides represented by the general formula of LiNiₓMn_{y}Co_{z}O₂ (x+y+z=1), lithium vanadium compounds, V₂O₅, olivine-type LiMPO₄ (where M is Co, Ni, Mn, or Fe), and lithium titanate (Li₃Ti₅O₁₂). Examples of the binders include the binders used in the electrode of the present invention mentioned above. Examples of the additives include the conductive auxiliary agent and oxides used in the electrode of the present invention mentioned above as necessary.

The electrolyte layer 4 may be a layer made of an electrolytic solution, a layer made of a solid electrolyte (ceramic solid electrolyte or solid polymer electrolyte), or a layer constituted by a separator and an electrolytic solution and/or solid electrolyte infiltrated in the separator.

The electrolyte is prepared by dissolving a lithium-containing electrolyte into a nonaqueous solvent. The lithium-containing electrolyte may appropriately be selected from LiClO₄, LiBF₄, LIPF₆, and the like, for example, whereas lithium imide salts such as Li(CF₃SO₂)₂N and Li(C₂F₅SO₂)₂N, LiB(C₂0₄)₂, and the like can also be used. The nonaqueous solvent can be selected from organic solvents such as ethers, ketones, and carbonates exemplified in Japanese Patent Application Laid-Open No. SHO 63-121260 and the like, for example. In particular, carbonates are preferably used in the present invention.

A mixed solvent, mainly composed of ethylene carbonate among the carbonates, having at least one species of other solvents added thereto is preferably used. It will usually be preferred if the mixing ratio is ethylene carbonate/other solvents=5 to 70:95 to 30 (volume ratio). Ethylene carbonate has such a high coagulation point of 36.4° C. that it is solidified at normal temperature. Therefore, ethylene carbonate cannot be used as an electrolytic solution for a battery by itself. When at least one species of other solvents having a lower coagulation point is added thereto, however, the coagulation point of the mixed solvent decreases, so as to become usable.

The other solvents in this case may be anything as long as it lowers the coagulation point of ethylene carbonate. Examples of the solvents include diethyl carbonate, dimethyl carbonate, propylene carbonate, 1,2-dimethoxyethane, methylethyl carbonate, γ-butyrolactone, γ-valerolactone, γ-octanoic lactone, 1,2-diethoxyethane, 1,2-ethoxymethoxyethane, 1,2-butoxyethane, 1,3-dioxolane, tetrahydrofuran, 2-methyltetrahydrofuran, 4,4-dimethyl-1,3-dioxane, butylene carbonate, and methyl formate. Using the electrode carbon material as the anode active material together with the mixed solvent remarkably improves the battery capacity, whereby the irreversible capacity ratio can sufficiently be lowered.

Examples of the solid polymer electrolyte include conductive polymers having an ionic conductivity.

The conductive polymers are not restricted in particular as long as they have a lithium ion conductivity, whereby their examples include those obtained by complexing monomers of polymer compounds (polyether-based polymer compounds such as polyethylene oxide and polypropylene oxide, cross-linked polymers of polyether compounds, polyepichlorohydrin, polyphosphazene, polysiloxane, polyvinylpyrrolidone, polyvinylidene carbonate, polyacrylonitrile, etc.) with lithium salts such as LiClO₄, LiBF₄, LiPF₆, LiAsF₆, LiCl, LiBr, Li(CF₃SO₂)₂N, and LiN(C₂F₅SO₂)₂ or an alkali metal salt mainly composed of lithium. Examples of polymerization initiators used for complexation include photopolymerization initiators and thermal polymerization initiators adaptable to the above-mentioned monomers.

Examples of supporting salts constituting the solid polymer electrolyte include salts such as LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), and LiN(CF₃CF₂CO)₂, and their mixtures.

When a separator is used in the electrolyte layer 4, examples of its constituent materials include at least one species of polyolefins such as polyethylene and polypropylene (two or more layers of films may be bonded together when two or more species are used), polyesters such as polyethylene terephthalate, thermoplastic fluorine resins such as ethylene/tetrafluoroethylen copolymers, and celluloses. Examples of modes of sheets include microporous films, woven fabrics, and nonwoven fabrics having an air permeability of about 5 to 2,000 seconds/100 cc determined by a method defined by JIS-P8117 and a thickness of about 5 to 100 μm. A monomer of a solid electrolyte may be infiltrated into the separator and then cured, so as to be used as a polymer. The above-mentioned electrolytic solution may be used as being contained in a porous separator.

The method of manufacturing a nonaqueous electrolyte battery in accordance with the present invention will now be explained. The method of manufacturing a nonaqueous electrolyte battery in accordance with the present invention is a method of manufacturing a nonaqueous electrolyte battery comprising an anode, a cathode, and an electrolyte layer, arranged between the anode and cathode, including a nonaqueous electrolyte, the method including an electrode forming step of forming at least one of the anode and cathode by way of the method of manufacturing an electrode in accordance with the present invention.

Here, the electrode forming step is a step of forming an electrode by way of the method of manufacturing an electrode of the present invention explained above, i.e., the manufacturing method including the plasma processing step, the active material containing layer forming step, and the storing step performed as necessary.

The method of manufacturing a nonaqueous electrolyte battery in accordance with the present invention can make a nonaqueous electrolyte battery by performing the following battery forming step after making the electrode by the electrode forming step. Namely, by using thus obtained electrode as at least one of (preferably both of) the anode 2 and cathode 3, arranging the electrolyte layer 4 between the anode 2 and cathode 3, and further accommodating and sealing them in a case when necessary, a nonaqueous electrolyte battery can be obtained.

Preferably, in the method of manufacturing a nonaqueous electrolyte battery in accordance with the present invention, all the manufacturing steps mentioned above are performed in an inert gas atmosphere. Here, all the manufacturing steps specifically refer to the electrode forming step and the battery forming step. Thus, it will be preferred if the electrode carbon material is kept from being exposed to the air in each of the manufacturing steps when making the nonaqueous electrolyte battery.

Though preferred embodiments of the present invention are explained in the foregoing, the present invention is not limited to the above-mentioned embodiments.

For example, the electrode of the present invention may have a configuration of a module in which a plurality of unit cells (each cell comprising the anode 2, the cathode 3, and the electrolyte layer 4 also acting as a separator) are laminated and held (packaged) in a state sealed within a predetermined case.

Here, the unit cells may be connected in parallel or in series. A battery unit in which a plurality of such modules are electrically connected together in series or in parallel, for example, may be constructed as well. For example, as such a battery unit, a cathode terminal of one module and an anode terminal of another terminal may electrically be connected to each other with a metal piece, so as to construct a serially connected battery unit.

When constructing the above-mentioned module or battery unit, protection circuits and PTC similar to those provided in conventional batteries may further be provided as necessary.

Though the explanation of the above-mentioned embodiment of the electrochemical device (nonaqueous electrolyte battery) relates to one having the structure of a rechargeable battery, it will be sufficient if the electrochemical device (nonaqueous electrolyte battery) of the present invention comprises, at least, an anode, a cathode, and an ionically conductive electrolyte layer, in which the anode and the cathode are arranged so as to oppose each other by way of the electrolyte layer, and may be a primary battery as well, for example. Here, the electrode active material may be one used in a conventional primary battery, whereas the binder and the conductive auxiliary agent or the like may be similar to materials exemplified in the above.

### EXAMPLES

In the following, the present invention will be explained more specifically with reference to examples and comparative examples, though the present invention is not limited to the following examples.

### Examples 1 to 8 and Comparative Example 1

Making of Electrode Carbon Material

Using a plasma torch such as the one shown in FIG. 1, mesophase carbon microbead (MCMB) was continuously dispersed as a carbon powder, and was subjected to high-frequency thermal plasma processing, so as to yield electrode carbon materials of Examples 1 to 8. The MCMB is spherical artificial graphite. In the high-frequency thermal plasma processing, the plasma gases listed in Table 1 were used with respective in-torch pressures shown in the same table. In all the examples, the frequency was 2 MHz, the input power was 40 kW, the powder feed rate was 1.6 g/min, and the time elapsed from the start of powder feed until the end of processing was 5 minutes. Here, the plasma temperature was 10,000° C. or higher according to a model calculation. On the other hand, the MCMB not subjected to high-frequency thermal plasma processing was defined as the electrode carbon material of Comparative Example 1.

TABLE 1

| | | | | In-torch |
|---|---|---|---|---|
| | Plasma gas [L/min] | | | pressure |
| | Central gas | Sheath gas | Carrier gas | [kPa] |
| Example 1 | Ar: 6 | Ar: 30 | Ar: 4.5 | 53 |
| | | H₂: 3 | SF₆: 0.5 | |
| Example 2 | Ar: 6 | Ar: 30 | Ar: 4.6 | 53 |
| | | H₂: 3 | SF₆: 0.4 | |
| Example 3 | Ar: 6 | Ar: 30 | Ar: 4.7 | 53 |
| | | H₂: 3 | SF₆: 0.3 | |
| Example 4 | Ar: 6 | Ar: 30 | Ar: 4.0 | 27 |
| | | H₂: 3 | SF₆: 1.0 | |
| Example 5 | Ar: 6 | Ar: 30 | Ar: 4.5 | 27 |
| | | H₂: 3 | SF₆: 0.5 | |
| Example 6 | Ar: 6 | Ar: 30 | Ar: 4.6 | 27 |
| | | H₂: 3 | SF₆: 0.4 | |
| Example 7 | Ar: 6 | Ar: 30 | Ar: 4.7 | 27 |
| | | H₂: 3 | SF₆: 0.3 | |
| Example 8 | Ar: 6 | Ar: 30 | Ar: 4.0 | 27 |
| | | H₂: 3 | SF₆: 1.0 | |

Analysis of Electrode Carbon Material

For each of thus obtained electrode carbon materials, the BET specific surface area (BET(N₂)) due to nitrogen adsorption, the BET specific surface area (BET(H₂O)) due to water adsorption, and the sulfur content [mass %] and fluorine content [mass %] based on the total amount of the electrode carbon material were determined. Tables 2 and 3 show the results. For the BET specific surface areas, each electrode carbon material dried by vacuum heating at 220° C. for 20 minutes was measured as a sample. Since the sulfur component present as an elementary substance sublimated upon the vacuum heating, the sulfur content was determined before the vacuum heating (b.v.) and thereafter (a.v.). The fluorine content was determined after the vacuum heating. Here, the sulfur content was determined by a sulfur/carbon analyzer (CS-444 manufactured by LECO Corporation), whereas the fluorine content was determined by quartz combustion tube decomposition/ion chromatography. Tables 2 and 3 show the results of calculation of the ratio (BET(N₂)/BET(H₂O)) between the BET specific surface area due to nitrogen adsorption and the BET specific surface area due to water adsorption, the remaining ratio of S after vacuum heating ({S content (a.v.)/S content (b.v.)}×100) [%] and the ratio between the S content (a.v.) and the fluorine content (S content (a.v.)/F content (b.v.)) [mol/mol].

TABLE 2

| | BET(N₂) | BET(H₂O) | BET(N₂)/ |
|---|---|---|---|
| | [m²/g] | [m²/g] | BET(H₂O) |
| Example 1 | 2.2 | 0.16 | 14 |
| Example 2 | 1.9 | 0.11 | 17 |
| Example 3 | 1.9 | 0.038 | 50 |
| Example 4 | 0.99 | 0.033 | 30 |
| Example 5 | 1.8 | 0.059 | 31 |
| Example 6 | 1.2 | 0.025 | 48 |
| Example 7 | 1.5 | 0.033 | 45 |
| Example 8 | 0.99 | 0.1 | 9.9 |
| Comparative | 1.4 | 0.026 | 54 |
| Example 1 | | | |

TABLE 3

| | | | | | S conten |
|---|---|---|---|---|---|
| | | | | | (a.v.) |
| | S content | S content | S | | [mol]/F |
| | (b.v.) | (a.v.) | remaining | F content | content |
| | [mass %] | [mass %] | ratio [%] | [mass %] | [mol] |
| Example 1 | 0.47 | 0.30 | 64 | 0.012 | 15 |
| Example 2 | 0.25 | 0.16 | 64 | 0.008 | 12 |
| Example 3 | 0.10 | 0.02 | 20 | below | — |
| | | | | measurement | |
| | | | | limit | |
| Example 4 | 1.20 | 0.07 | 6 | 0.003 | 14 |
| Example 5 | 1.06 | 0.08 | 8 | 0.006 | 8 |
| Example 6 | 0.55 | 0.04 | 7 | below | — |
| | | | | measurement | |
| | | | | limit | |
| Example 7 | 0.35 | 0.03 | 9 | 0.004 | 4 |
| Example 8 | 1.20 | 0.07 | 6 | 0.003 | 14 |
| Compar- | 0 | 0 | 0 | 0 | 0 |
| ative | | | | | |
| Example 1 | | | | | |

It can be seen from the results shown in Table 2 that the BET(N₂) tends to become greater in the plasma-processed electrode carbon materials than in the electrode carbon material of Comparative Example 1 (MCMB without the high-frequency thermal plasma processing). The decrease of BET(N₂) in Example 4 seems to result from a reduction in the specific surface area caused by an etching effect because of a large amount of SF₆ added.

It can be seen from the results shown in Table 3 that the S content before vacuum heating tends to be higher when the in-torch pressure is 27 kPa than when it is 53 kPa. On the other hand, the S remaining ratio after the vacuum heating tends to be lower when the in-torch pressure is 27 kPa than when it is 53 kPa. From these facts, a greater amount of elementary sulfur seems to be deposited on the electrode carbon material by the high-frequency thermal plasma processing when the pressure is lower, whereas the ratio by which sulfur exists as a surface functional group containing sulfur not isolated by heating or the like seems to be higher when the pressure is higher.

In the electrode carbon materials of Examples 1 and 2 exhibiting a large S content after the vacuum heating, as can be seen from the results shown in Tables 2 and 3, the BET specific surface area due to water adsorption is higher, whereby the ratio of the BET specific surface area due to nitrogen adsorption to the BET specific surface area due to water adsorption is lower. Thus exhibited interaction with water suggests the existence of a surface functional group containing S.

Making of Electrodes

Electrodes were made by using the respective electrode carbon materials mentioned above. When making the electrode by using the electrode carbon material of Example 8, after making the electrode carbon material by performing the high-frequency thermal plasma processing, carbon powder was sealed into a closed container within a processing apparatus, and then the closed container was immediately transferred into a glove box in a dry Ar gas flow atmosphere (with a dew point of −80° C. or lower), whereby the following electrode making operation was also wholly performed in the glove box such that the electrode carbon material was not exposed to the air.

In the following manner, the electrode making operation was performed. First, a binder made of polyvinylidene fluoride sufficiently dried by heating under reduced pressure within a dry Ar gas was mixed with the electrode carbon material at a ratio of carbon powder/binder=90:10. Thus obtained mixture was kneaded with N-methylpyrrolidone which had sufficiently been dried by heating under reduced pressure within a dry Ar gas, so as to prepare an active material layer forming coating liquid.

This active material layer forming coating liquid was applied onto a copper foil (collector) of 15 mm×15 mm×0.1 mm such as to yield a two-dimensional size of 10 mm×10 mm by metal mask printing, and then was dried by heating in a dry Ar gas flow at 150° C. for 30 minutes and subsequently under vacuum at 200° C. for 1 hour. Thereafter, the copper foil was punched out into a diameter of 14 mm about the area formed with the coating film, whereby the electrodes of Examples 1 to 8 and Comparative Example 1 were obtained.

Electrode Characteristic Evaluation 1

While using the above-mentioned electrodes (Examples 1 to 8 and Comparative Example 1) as operating electrodes, metal lithium was used for their counter electrodes also functioning as reference electrodes. As an electrolytic solution, one in which LiPF₆ was dissolved in a mixed solvent such as to yield a concentration of 1 M was used. Employed as the mixed solvent was one in which ethylene carbonate and dimethyl carbonate were mixed by a volume ratio of 1:1.

At the time of charging/discharging measurement, from the first to third measurement operations, the current density was set to a low value of 0.25 mA/cm² such that the capacity and the charging and discharging efficiency were less likely to be kinetically affected, the charging was performed up to 0 V vs. Li, the discharging was performed until the voltage became 3 V vs. Li, and the discharging capacity at the third measurement was defined as a reversible capacity. Table 4 shows the results of measurement of reversible capacity and initial charging and discharging efficiency.

TABLE 4

| | | Initial charging |
|---|---|---|
| | Reversible | and discharging |
| | capacity [mAh/g] | efficiency [%] |
| Example 1 | 302 | 91.7 |
| Example 2 | 300 | 91.4 |
| Example 3 | 299 | 91.4 |
| Example 4 | 317 | 91.5 |
| Example 5 | 312 | 91.8 |
| Example 6 | 308 | 92.0 |
| Example 7 | 304 | 92.2 |
| Example 8 | 325 | 94.5 |
| Comparative | 280 | 90.3 |
| Example 1 | | |

Electrode Characteristic Evaluation 2

While using the above-mentioned electrodes (Examples 4, 5 and Comparative Example 1) as operating electrodes, metal lithium was used for their counter electrodes also functioning as reference electrodes. As an electrolytic solution, one in which LiPF₆ was dissolved in a mixed solvent such as to yield a concentration of 1 M was used. Employed as the mixed solvent was one in which propylene carbonate and dimethyl carbonate were mixed by a volume ratio of 1:1.

At the time of charging/discharging measurement, from the first to third measurement operations, the current density was set to a low value of 0.25 mA/cm² such that the capacity and the charging and discharging efficiency were less likely to be kinetically affected, the charging was performed up to 3 V vs. Li, the discharging was performed until the voltage became 1 V vs. Li, and the discharging capacity at the third measurement was defined as a reversible capacity. Table 5 shows the results of measurement of reversible capacity.

TABLE 5

| | Reversible |
|---|---|
| | capacity [mAh/g] |
| Example 4 | 80 |
| Example 5 | 60 |
| Comparative | 0 |
| Example 1 | |

### INDUSTRIAL APPLICABILITY

As explained in the foregoing, the present invention can provide an electrode carbon material which can sufficiently reduce the irreversible capacity. Also, the present invention can provide an electrode which can sufficiently reduce the irreversible capacity. Further, the present invention can provide a nonaqueous electrolyte battery which can sufficiently reduce the irreversible capacity and yield a sufficient reversible capacity and charging and discharging efficiency (initial charging and discharging efficiency in particular).

Furthermore, the present invention can provide methods which can easily and reliably yield the electrode carbon material, electrode, and nonaqueous electrolyte battery of the present invention.

1. An electrode carbon material to become a constituent material for an electrode of a nonaqueous electrolyte battery;
wherein the electrode carbon material is formed by way of a plasma processing step of subjecting a material composition to high-frequency thermal plasma processing in a plasma gas atmosphere including a sulfur-containing compound.

2. An electrode carbon material according to claim 1, wherein the electrode carbon material has a BET specific surface area of 0.5 to 300 m²/g.

3. An electrode carbon material according to claim 1, wherein the electrode carbon material contains 0.02 to 6 mass % of sulfur based on the total amount of the electrode carbon material and is used as a constituent material for an anode.

4. An electrode carbon material according to claim 1, wherein the electrode carbon material contains 1.2 to 18 mass % of sulfur based on the total amount of the electrode carbon material and is used as a constituent material for a cathode.

5. An electrode carbon material according to claim 1, wherein the electrode carbon material is capable of inserting and desorbing a lithium ion.

6. An electrode for a nonaqueous electrolyte battery;
the electrode comprising:
an active material containing layer including the electrode carbon material according to claim 1 and a binder capable of binding the electrode carbon material as constituent materials; and
a conductive collector arranged in a state electrically in contact with the active material containing layer.

7. A nonaqueous electrolyte battery comprising:
an anode;
a cathode; and
an electrolyte layer, arranged between the anode and cathode, including a nonaqueous electrolyte;
wherein at least one of the anode and cathode is the electrode according to claim 6.

8. A nonaqueous electrolyte battery comprising:
an anode;
a cathode; and
an electrolyte layer, arranged between the anode and cathode, including a nonaqueous electrolyte:
wherein each of the anode and cathode is the electrode according to claim 6.

9. A method of manufacturing an electrode carbon material to become a constituent material for an electrode of a nonaqueous electrolyte battery;
the method including a plasma processing step of subjecting a material composition to high-frequency thermal plasma processing in a plasma gas atmosphere including a sulfur-containing compound.

10. A method of manufacturing an electrode for a nonaqueous electrolyte battery;
the method including:
a plasma processing step of subjecting a material composition to high-frequency thermal plasma processing in a plasma gas atmosphere including a sulfur-containing compound, so as to yield an electrode carbon material; and
an active material containing layer forming step of forming an active material containing layer including the electrode carbon material and a binder capable of binding the electrode carbon material as constituent materials in a state electrically in contact with a conductive collector.

11. A method of manufacturing an electrode according to claim 10, further comprising a storing step of, after the active material containing layer forming step, sealing the obtained electrode into a case capable of storing the electrode in a closed state.

12. A method of manufacturing an electrode according to claim 10, wherein all the manufacturing steps are performed in an inert gas atmosphere.

13. A method of manufacturing a nonaqueous electrolyte battery comprising an anode, a cathode, and an electrolyte layer, arranged between the anode and cathode, including a nonaqueous electrolyte;
the method including an electrode forming step of forming at least one of the anode and cathode by way of the method of manufacturing an electrode according to claim 10.

14. A method of manufacturing a nonaqueous electrolyte battery comprising an anode, a cathode, and an electrolyte layer, arranged between the anode and cathode, including a nonaqueous electrolyte.
the method including an electrode forming step of forming each of the anode and cathode by way of the method of manufacturing an electrode according to claim 10.

15. A method of manufacturing a nonaqueous electrolyte battery according to claim 13, wherein all the manufacturing steps are performed in an inert gas atmosphere.
